(19) United States
(12) Patent Application Publication
(10) Pub. No.: US 2014/0003614 A1
(43) Pub. Date: Jan. 2, 2014

(54) NEONATAL INCUBATOR

(71) Applicants: Alex Levitov, Norfolk, VA (US); Chris Fuller, Virginia Beach, VA (US)

(72) Inventors: Alex Levitov, Norfolk, VA (US); Chris Fuller, Virginia Beach, VA (US)

(21) Appl. No.: 13/710,862

(22) Filed: Dec. 11, 2012

Related U.S. Application Data
(60) Provisional application No. 61/569,384, filed on Dec. 12, 2011.

(51) Int. Cl. G10K 11/00

(52) U.S. Cl. CPC G10K 11/002
USPC 381/71.7

(57) ABSTRACT

A neonatal incubator with sound canceling features to minimize injury to the neonate. Internally developed sounds and external ambient noise are cancelled at the location of the infant's head.

### CROSS REFERENCE TO RELATED CASES

This case is the Utility Application conversion of U.S. Provisional Application 61 /569,384, filed Dec. 12, 2011.

### BACKGROUND OF THE INVENTION

Neonatal intensive care units are noisy places and it is believed that exposure to high sound levels can injure premature babies or other newborn Typically neonates needing intensive medical care are typically sheltered in an enclosure called an “incubator”. The typical incubator has a bed for the neonate within a Plexiglas enclosure. The child lies on the bed and the atmosphere in the incubator is circulated and controlled for heat level. Most incubators are ventilated by a fan system integrated into the incubator and operated automatically with a closed loop feed back system. Many incubators also have a device for respiratory support for the child closely associated with the enclosure and typically attached to it. In general the heating, ventilation and respiratory support equipment all contribute noise to the enclosure. Although multiple wall enclosures are known, most enclosures are transparent to sounds within the vicinity of the enclosure and thereby increase the sound level present at the child ears. In short the child is contained within a noisy cage within a noisy environment. For these reasons the child is exposed to potentially dangerous sound pressure levels.

### SUMMARY OF THE INVENTION

The neonatal incubator of the present invention includes an enclosure surrounding an infant bed. A monitoring microphone is located within the enclosures to monitor sound pressure levels near the child's ears. A reference microphone is present outside the enclosure but associated with the enclosure to measure ambient sound pressure levels. One or more sound transducers (speakers) are mounted on the enclosure to deliver and modulate sound within the enclosure.

One or more accelerometers are attached to the incubator to sense vibrations of the enclosure and a shaft encorder or the like is used to monitor the fan associated with air movement in the enclosure.

An active feed forward noise canceling system uses the microphones and other transducers to effectively lower the sound pressure level at the child's ears within the enclosure over a wide set of frequencies. Reverberations within the enclosures are reduced and a relatively broad band of noise reduction is achieved in comparison to the otherwise normal sound levels. In contrast to prior art systems the noise-canceling network includes as inputs both the random noise in the environment and the periodic noise associated with rotating machinery associated with the incubator enclosure. The utilization of both periodic noise inputs along with periodic noise inputs improves the attenuation performance of the system over levels achieved in the prior art.

### BRIEF DESCRIPTION OF THE DRAWINGS

Throughout the figures identical reference numerals indicate identical structure wherein:

FIG. 1 is a side view of the incubator;

FIG. 2 is a plan view of the incubator;

### DETAILED DESCRIPTION OF THE DRAWINGS

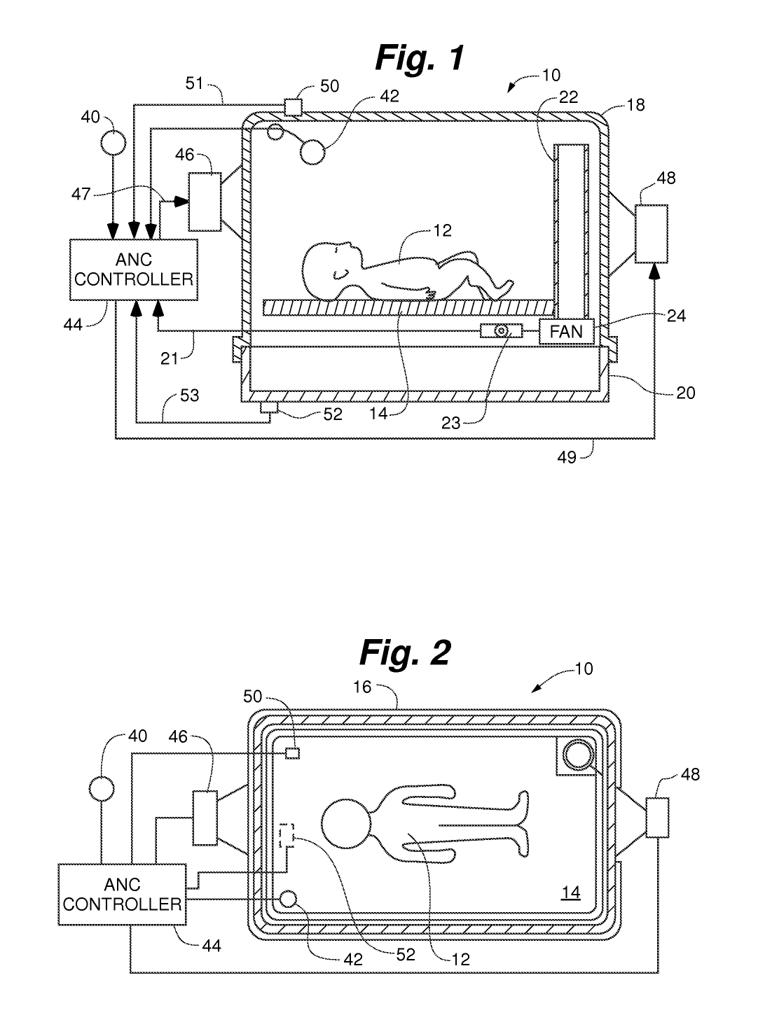

FIG. 1 shows the neonatal incubator 10 in cross-section, while FIG. 2 shows a plan view of the same structures. The child 12 lies on a bed 14 within an enclosure 16. In this example the enclosure 16 includes a base 18 and a cover 20. A door or port (not shown) permits easy access to the child. A fan 24 and associated ducting 22 circulate air within he enclosure.

The active noise control features include a measurement microphone 42 located within the enclosure 16 and a reference microphone 40. The microphones are coupled to an active noise control system controller 44 which drives one or more acoustic transducers typified by speaker 46 and speaker 48 via cables 47 and 49. One or more accelerometers may be provided to supply vibration information as well to the controller 44. For example an accelerometer 52 may be coupled to the base 18 and one may be coupled to the cover 20 as indicated at reference numeral 50. Signal paths 51 and 53 respectively carry information to the controller 44.

The fan unit 24 will typically have a rotating shaft and an optical shaft encoder or the like can measure the operating frequency of the fan. The encoder 23 sends data to the controller 44 via a signal path 21.

In operation the microphones and accelerometer and shaft encoder present real time measurements of the acoustic environment to the active noise controller 44 (ANC). The input “noise” is measured over a broad range of frequencies extending from low frequency rumble and shaking vibrations to the very high frequency squeaks and whistles. The ANC 44 derives a correction signal and drives the speakers to cancel out a portion of the noise through a process of destructive interference.

The active noise controller 44 can take any of many forms but in the instant example, the interior of the incubator enclosure is considered the environment to be controlled and sound detected within the enclosure near the infants ears is detected and feed forward to drive the acoustic transducers via a control signal to destructively interfere with the acoustic energy within the enclosure. The exterior microphone provides an error signal to drive the speaker toward destructive interference. The overall system is in essence a single channel feed forward network to cancel random noise and periodic noise.

### Experimental Example

A study was performed to determine the sound levels, sound spectra and major sources of sound within a modern neonatal incubator (Giraffe Omnibed®, GE Healthcare, Finland) using a sound simulation study to replicate the conditions of a preterm infant undergoing high frequency jet ventilation (Life Pulse®, Bunnell, Utah).

Using advanced sound data acquisition and signal processing equipment, we measured and analyzed the sound level at a dummy infant's ear and at the head level outside the enclosure. The sound data was processed using an FFT algorithm to provide spectra of the sound and cumulative SPL (dBA). The simulation was done with the incubator cooling fan and ventilator switched on or off. In addition tests were carried out with the enclosure sides closed or open in order to determine the importance of interior reverberance on the interior sound level.

With all the equipment off and the hood down, the SPL was 53 dB(A) inside the incubator. The SPL increased to 68 dB(A) with all equipment switched on (approximately 10 times louder than recommended). The sound intensity was 6.0×10⁻⁸ watts/m²; this sound level is roughly comparable with that generated by an operating washing machine. Turning the ventilator off reduced the overall SPL to 64 dB(A) and the SPL in the low frequency band of 0 to 100Hz was reduced by 10 dB(A). The incubator fan generated tones at 200, 400 and 600 Hz that raised the sound level by approximately 2-3 dB(A). Opening the enclosure (with all equipment turned on) reduced the sound levels above 50 Hz by reducing the reverberation.

In addition to sound level data a measurement of vibration within the enclosure was made as well. A PCB™ mini-accelerometer (Depew, N.Y.) was used to simultaneously acquire vibration signals using the same DAQ system. This signal was analyzed using an FFT to determine frequency components and also used to calculate the coherence between the vibration signal and the interior microphone signal. A high coherence indicates a strong energy relationship between the two signals and indicates that the vibration is the main source of noise at the microphone. The accelerometer was located on the top casing of the Whisper Jet Patient Box®.

Sound at the microphones was measured under various operating conditions of the incubator in order to determine the major noise sources. There were two main operating conditions; incubator on/off (cooling fan on/off) and ventilator on/off. Different combinations of these conditions were tested. In addition, tests were carried out with the enclosure sides closed or open in order to determine the importance of interior reverberance on the interior sound levels. For some testing an accelerometer was used to measure the spectrum of vibration of a chosen noise source. The coherence between the accelerometer and interior microphones signals were calculated to indicate whether these sources of vibration were significant noise sources.

With all the equipment off and the hood down the SPL was 53 dB(A) inside the incubator and 58 dB(A) outside the incubator. The enclosure provided negligible attenuation of exterior background noise at low frequencies (less than 500 Hz), which is typical of all lightweight acoustic enclosures. The SPL within the incubator with all equipment switched on was 68 dB(A). It should be noted that the sound spectra within the incubator with the incubator cooling fan on and with the ventilator switched on and off, revealed that turning the ventilator off eliminates the low frequency tones between 20 to 120 Hz. These high sound levels are due to noise generated by the high-frequency ventilator and Whisper Jet Patient Box®; eliminating this noise would reduce the sound levels up to 100 Hz by over 12 dB(A) and up to 2000 Hz by up to 4 dB(A). An examination of data also shows the presence of a large tone at 200 Hz as well as other significant tones at 400 and 600 Hz. This tone and its harmonic are very likely due to the cooling fan located in the base of the enclosure (as shown in FIG. 1). With 8 blades rotating at 1500 rpm, the predicted fundamental fan tone frequency is 8×1500/60=200 Hz, supporting the cooling fan as being the source of this tone and its harmonics. It has been observed that the tone at 200 Hz raises the overall level by approximately 2-3 dB(A). Turning the fan off eliminates the tones at 200, 400 and 600 Hz thus confirming it as the source of this noise and reducing the overall level by approximately 3 dB(A). In a comparison, the interior SPL with the sides of the enclosure down and hood up to the enclosure fully sealed. It is evident when the enclosure is opened that the ventilator sound levels above 50 Hz are much reduced indicating that reverberance within the enclosure leads to increased SPL in the 50 to 120 Hz bandwidth of the ventilator tones and an increase in overall SPL of 5 dB(A). The sealed enclosure also led to an increase in broadband noise at higher frequencies and this was likely due to reverberant amplification of fan flow noise. Finally, we compared the spectra of an accelerometer located on the Whisper Jet Patient Box® and the noise at the dummy baby's ear. We then calculated the coherence between the accelerometer and the microphone signal. The results of these tests demonstrated that the frequencies of the tones of the microphone in the 50 to 120 Hz bandwidth lined-up perfectly with the frequencies of the tones of the vibration of the Whisper Jet Patient Box®. In addition the calculated coherence between the microphone and the accelerometer at these tonal frequencies was close to 1.0 verifying the Whisper Jet Patient Box® to be the source of the low frequency tones in the enclosure.

Despite standard environmental and behavioral measures to reduce noise in our NICU, the SPL within the incubator with all equipment off was 53 dB(A). The SPL increased to 68 dB(A) with all equipment turned on. This level of sound is in excess of 10 times that recommended by the American Academy of Pediatrics (threshold <45 dBa). It is likely that this intensity of noise is harmful to the maturing preterm infant. In this study we demonstrated the high-frequency ventilator and Whisper Jet Patient Box® together with the incubator fan to be the major sources of noise within the incubator. This observation is important as the relative contribution of the inside and outside sound is critical to determine strategies to reduce the sound level within the incubator. Our results are similar to those of Altuncu and co-authors who reported the SPL of background noise inside the NICU to be 56 dB(A) which decreased to 47 dB(A) within the incubator (with no equipment switched on).[15] While these authors did not test the effects of the incubator fan or ventilator, they noted that factors such as alarms, porthole and isolette door closing increased the sound levels up to 82 dB(A).

Our data indicate that the incubator provides some protection from background noise but provides no protection from the noise generated by the incubator itself. Indeed, due to reverberance effects, the incubator increases noise that is generated within the enclosure. Our data suggest that the incubator and attached respiratory equipment may be the major source of noise within the incubator. Our findings are at odds with the current recommendations for noise reduction. These recommendations focus on reducing environmental noise and the loudness of human speech. NICU environmental noise has been presumed to be the most important contributors to the noise level recorded within the neonatal incubator. [16-18] Previous studies suggested that monitors, nebulizers, alarms and staff talking were the major contributors of high noise levels. Consequently most of the interventions have been aimed at environmental control such as “soft voices”, soft shoes, encouraging staff to answer alarms quickly, restricting teaching rounds at the bedside and restricting visitors. However, research in this area has demonstrated that implementation of coordinated programs of noise reduction had no measurable improvement on sound levels in the NICU. In addition, it has also been assumed that neonatal jet ventilators are not a major contributor to noise levels within the incubator.

This assumption was based on the study of Hoehn and colleagues. In this study, the authors compared the noise levels caused by four different neonatal high-frequency jet ventilators. The noise level within the incubator with the ventilators operating ranged from 54 to 70 dB(A) , however, as the sound level was consistently above 65 dB(A) without the ventilators being connected, the authors concluded that “neonatal high-frequency ventilators do not represent a major contribution to noise levels.”

Despite the fact that the Giraffe Omnibed ® Incubator (GE Healthcare, Finland) is a highly advanced, microprocessor controlled incubator with double plexi-glass walls and Whisper Quiet Technology™ the noise levels within the incubator during normal operating conditions far exceeded those permissible by the American Academy of Pediatrics. As the preterm's brain is still developing and highly vulnerable, it is likely that such sustained noise levels may have permanent neurological squeal. While there has been limited research in this area, this postulate is supported by the pilot study of Turk and colleagues.

These authors randomized 34 very low weight newborns to an earplug intervention or control group. After adjusting for birth weight the earplug newborns that survived had a significantly greater weight at 34 weeks post menstrual age than the control group (adjusted weight difference of 225 g, p=0.017). In a follow-up assessment of the 15 surviving newborns conducted between the ages of 18 and 22 months, the earplug group tended to be heavier, taller, have larger heads (p=0.005) and outperformed the control group on the Bayley Mental Developmental Index (p=0.02). While earplugs would appear to be a simple, cost-effective intervention, such an intervention requires diligent nursing attention. Furthermore, earplugs provide limited protection across the spectrum of sound frequencies and are far less effective at low frequencies. Since the ventilator noise is very low frequency, it would be difficult to attenuate this noise with passive sound control measures alone. This is supported by the fact that the Whisper Jet Patient Box® is already in a thick plexi-glass enclosure which does little to attenuate the low frequency noise.

It should be noted that the sound levels in the tones below 100 Hz might induce physical effects such as induced vibration in the developing newborn within the incubator very similar to the physical effects of a large subwoofer speaker. In addition, recent research has indicated that infrasound (frequencies below 20 Hz and thus not perceived) may have detrimental and harmful effects on humans. [22-25] We noted the presence of these very low frequency tones at significant levels within the enclosure. The effects of induced vibration and infrasound on the health of developing newborns are unknown, but is also likely to be detrimental.

In conclusion, we have demonstrated that the sound levels with a modern incubator may reach levels that are likely to be harmful to the developing newborn. Environmental and human behavior modifications are unlikely to have a meaningful impact on reducing the noise levels within the incubator. A combination of active and passive noise cancellation modifications of neonatal incubators are required to address this issue.

What is claimed is:

1. A neonatal incubator for an infant comprising:
an enclosure having a bottom and a close fitting top;
said bottom adpted to receive a neonatal cushion, for positioning and orienting said infant;
a sound output transducer positioned proximate said infants head;
a first microphone positioned proximate said infants head;
a reference microphone positioned outside said enclosure;
an accelerometer coupled to said enclosure;
said first and reference microphones and said accelerometer and said sound output transducer coupled to a feed forward active noise canceling network (ANC) for reducing sound pressure levels at the location of said infants head.

2. The device of claim 1 further comprising:
a fan located within said enclosure;
a shaft encoder coupled to said fan and said ANC for supplying a proxy for fan noise directly to said ANC.
